(19) United States
(12) Patent Application Publication
(10) Pub. No.: US 2009/0223468 A1
(43) Pub. Date: Sep. 10, 2009

(54) Valve-deactivating oil manifold assembly having an integral direct injection fuel pump and roller hydraulic pump lifter

(76) Inventors: Daniel F. Smith, Conesus, NY (US); Dominic Borraccia, Spencerport, NY (US); Timothy W. Kunz, Rochester, NY (US)

Correspondence Address: DELPHI TECHNOLOGIES, INC., M/C 480-410-202, PO BOX 5052, TROY, MI, 48007, US

(21) Appl. No.: 12/074,682

(22) Filed: Mar. 5, 2008

(51) Int. Cl. F02M 37/14; F01L 9/02

(52) U.S. Cl. 123/90.13; 123/502

(57) ABSTRACT

An improved lifter-oil manifold assembly (LOMA) for variable actuation of combustion valves in an internal combustion engine, comprising a body formed preferably of first and second plates having portions of oil flow passages integrally molded therein. A plurality of individual solenoid-actuated oil control valves is retained by a retainer in sockets formed in the plates. An integral electrical leadframe provides circuitry for energizing the solenoids. A DIFP is mounted to the LOMA and an RHPL engages the DIFP. Preferably, the RHPL and DIFP are lubricated by an oil orifice in the LOMA, and preferably the DIFP and RHPL are disposed in a central symmetry plane of the engine.

### TECHNICAL FIELD

The present invention relates to internal combustion engines; more particularly, to devices for controlling systems in an internal combustion engine; and most particularly, to an integrated hydraulic manifold assembly comprising oil control valves and oil flow passages for controlling the flow of engine oil especially in variable activation and deactivation of valve lifters, a direct injection fuel pump mounted on and extending through the manifold assembly, and an integral hydraulic pump lifter engaged with the fuel pump.

### BACKGROUND OF THE INVENTION

In conventional prior art four-stroke internal combustion engines, the mutual angular relationships of the crankshaft and the opening and closing of the combustion valves are mechanically fixed; that is, the valves are opened and closed fully and identically with every two revolutions of the crankshaft by a camshaft rotationally driven by the crankshaft and mounted above the crankshaft with an axis of rotation parallel to the axis of rotation of the crankshaft. Further, a fuel/air mixture is drawn into each cylinder in a predetermined sequence, the mixture is ignited by the sparking plug, and the burned residue is discharged.

It is known that for much of the operating life of a multiple-cylinder engine, the load can be met by a functionally smaller engine having fewer firing cylinders, and that at low-demand times fuel efficiency can be improved if one or more cylinders of a larger engine is withdrawn from firing service. It is known in the art to accomplish this by de-activating the valve trains leading to pre-selected cylinders (for example, one bank of intake and exhaust valves in a V-style engine) in any of various ways, such as by providing deactivating hydraulic valve lifters (DHVLs), deactivating roller finger followers (DRFFs), or deactivating hydraulic lash adjusters (DHLAs) having internal locks which may be switched on and off either electrically or hydraulically. (As used herein, DHVLs should be taken to mean generically any such hydraulically-switched deactivating device.)

It is known in the prior art to controllably distribute oil to DHVLs to operate the DHVLs via an oil manifold mounted to the top of the engine block and connected to an oil riser in the engine block. Such a manifold in known in the art as a Lifter Oil Manifold Assembly (LOMA). A typical LOMA is disclosed in U.S. Pat. No. 6,817,325, issued Nov. 16, 2004, which is incorporated herein by reference.

Fuel injected gasoline engines have been commonplace in the automotive industry for some time. Fuel injection of the most current technology has evolved into two categories: multi-port fuel injection (MPFI), wherein fuel is injected by one or more relatively low-pressure fuel injectors into the runners of an air intake manifold ahead of the cylinder air intake valves, and direct fuel injection (DFI) wherein fuel is injected by dedicated high-pressure fuel injectors directly into the engine cylinders, typically during or at the end of the compression strokes of the pistons. Diesel fuel injection is also a direct injection type.

Direct injection fuel delivery systems operate at much higher fuel pressures than do MPFI fuel delivery systems to assure proper injection of fuel into a cylinder having a compressed charge. DFI fuel rails that supply fuel to the fuel injectors may be pressurized to 100 atmospheres or more, for example, whereas MPFI fuel rails must sustain pressures of only about 4 atmospheres.

Fuel delivery for MPFI systems has been achieved, for the most part, by an electric fuel pump mounted in the fuel tank. Fuel is delivered under relatively low pressure from the fuel tank to the fuel rail(s) mounted on the engine via a fuel line running the length of the vehicle. Because of the higher delivery pressures needed in a direct injection system, current direct injection engine arrangements typically incorporate a high pressure mechanical direct injection fuel pump (DIFP) actuated by a lifter such as a roller hydraulic pump lifter (RHPL) and driven by a dedicated camshaft, wherein the DIFP is mounted close to the fuel rails(s) to minimize the length of high-pressure fuel line and the number of line connections between the pump and the engine fuel rails(s).

In the prior art, a LOMA for a V-style engine occupies the entire valley between the engine cylinder banks and makes it difficult to mount the RHPL or a DIFP in line with the engine camshaft. In such an engine, an RHPL typically is driven by an offset jack shaft drivably connected to the engine camshaft. This arrangement requires an undesirable number of additional components and also typically removes the DIFP from its optimum location adjacent the engine fuel rail on top of the engine where DIFP is protected from the environment.

What is needed in the art is a LOMA that integrates a network of oil flow passages and individual solenoid-operated OCVs with a DIFP and an RHPL directly actuable by a camshaft located on the centerline of a V-style engine.

Such an integrated LOMA has the further advantage that it may be fully pre-assembled and tested for leaks and functionality prior to its being mounted to an engine on an engine assembly line, thus increasing the reliability of finished engines and reducing the amount of engine rework resulting from faulty LOMAs, RHPLs, and DIFPs.

It is a principal object of the present invention to simplify the assembly, and to reduce assembly costs, of an internal combustion engine having direct fuel injection and variable valve activation via a plurality of DHVLs.

### SUMMARY OF THE INVENTION

Briefly described, an improved lifter-oil manifold assembly (LOMA) in accordance with the invention for managing pressurized oil delivered to the DHVLs and for delivering pressurized fuel to the direct injector cylinders comprises a body formed preferably of first and second plates and having portions of oil flow passages integrally molded therein. The plates are formed preferably by injection molding of a suitable high temperature thermoplastic polymer and are joined together as by cementing or vibration welding along mating surfaces. One of the plates is specially formed, and a retainer may be provided, for retaining a plurality of individual solenoid-actuated valves in operational disposition in sockets formed in the plate. An integral electrical leadframe provides circuitry for energizing the solenoids.

A DIFP is mounted to the LOMA and a fuel pump lifter, such as an RHPL, engages the DIFP on one end and an engine camshaft lobe on another end. An added advantage of mounting the DIFP and RHPL on the LOMA is that one or both may be lubricated by an oil orifice in the LOMA. Preferably the DIFP and RHPL are disposed in a central plane of the engine directly above the engine camshaft. Thus, the need for a separate jack shaft to actuate the DIFP is not necessary.

### BRIEF DESCRIPTION OF THE DRAWINGS

The present invention will now be described, by way of example, with reference to the accompanying drawings, in which:

FIG. 1 is an isometric view from above of an integrated LOMA in accordance with the present invention;

FIG. 2 is an end view of the top plate of the integrated LOMA shown in FIG. 1;

FIG. 3 is an isometric view from below of the top plate shown in FIGS. 1 and 2, showing oil passages formed in the top plate and a DIFP and RHPL mounted to the top plate; and

FIG. 4 is an exploded isometric view from above of an integrated LOMA in accordance with the present invention for V-style engines having a plurality of DHVLs.

Corresponding reference characters indicate corresponding parts throughout the several views. The exemplification set out herein illustrate one presently preferred embodiment of the invention, and such exemplification is not to be construed as limiting the scope of the invention in any manner.

### DESCRIPTION OF THE PREFERRED EMBODIMENTS

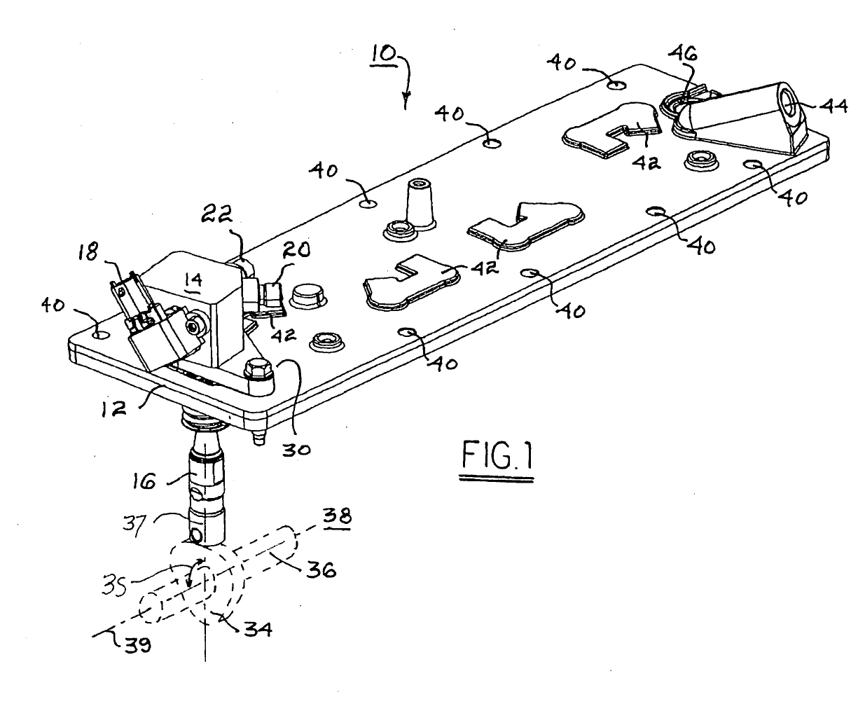

Referring to FIGS. 1 through 3, an integrated LOMA 10 in accordance with the present invention comprises a LOMA top plate 12 supportive of a DIFP 14 and RHPL 16 mounted thereto. DIFP 14 may be a conventional high-pressure piston pump as is well known in the prior art. DIFP 14 includes an electrical connector 18, a fuel inlet 20, a fuel outlet 22 for connection to a fuel rail (not shown), and a piston return spring 24 grounded to LOMA top plate 12 and having a socket 26 for receiving the head 28 of RHPL 16. DIFP 14 is mounted to an upper surface 30 of LOMA top plate 12 and extends through LOMA top plate 12.

RHPL 16 is mounted to socket 26 of DIFP 14 and may include a roller 32 that engages a dedicated lobe 34 of a camshaft 36 of an internal combustion engine 38. In a V-style engine, axis 39 of camshaft 36 typically lies in a central symmetry plane 41 of the engine. RHPL 16 is similar in construction to hydraulic lash adjusters and hydraulic valve lifters as are well known in the prior art, but having a head 28 adapted for pivotably mounting into socket 26. In one aspect of the invention, longitudinal axis 37 of RHPL 16 intersects and is substantially perpendicular 45 to camshaft axis 39 for compact operation. During engine assembly, RHPL 16 is disposed in a conventional bore (not shown) in engine 38 and is provided with lubricating and lash-removal oil via a conventional engine oil gallery (not shown).

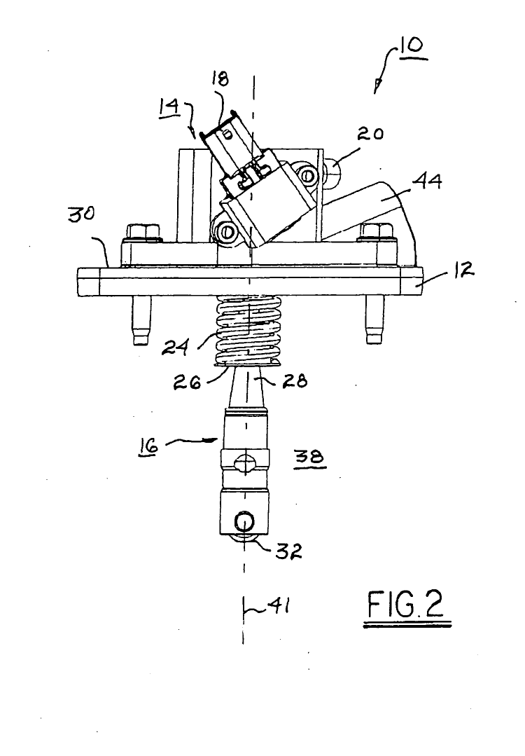

LOMA top plate 12 includes a plurality of bores 40 for mounting the integrated LOMA to engine 38, for example, within a valley of a V-style engine and may further include raised sections 42 that contain at least portions of oil passages (not visible in FIGS. 1 and 2) for supplying engine oil or other hydraulic fluid to individual lifters or lash adjusters (not shown) in engine 38. In a single-plate LOMA, the oil passages are entirely internal to LOMA plate 12 and may be formed during molding thereof by lost mold process, as is well known in the prior art. In a multiple-plate LOMA, as disclosed in the incorporated reference, portions of the oil passages are formed in the various plates which then are joined to form the entire network of oil passages.

A first port 44 is provided for attachment of an oil pressure sensor (not shown), and a second port 46 is provided for passage of an electrical leadframe connector as described below.

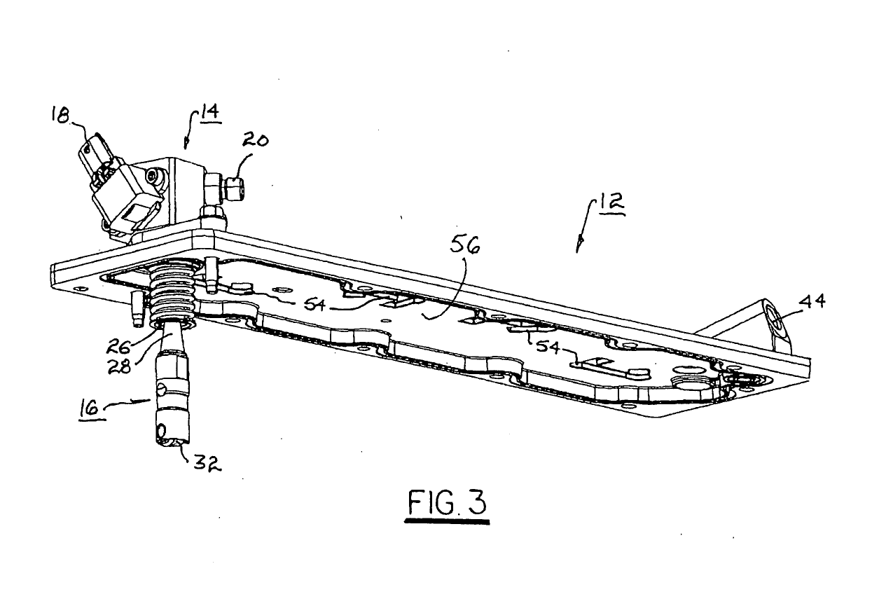

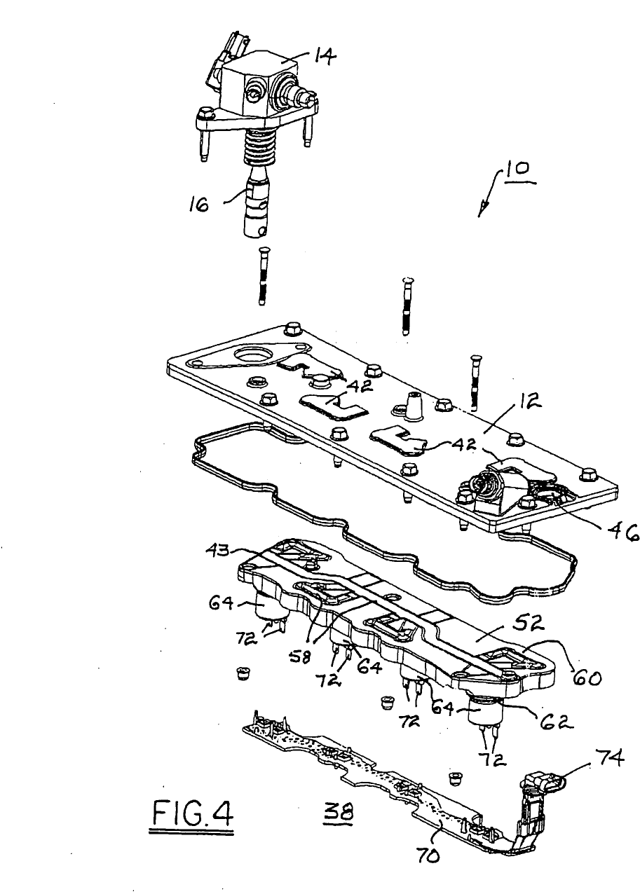

Referring to FIGS. 3 and 4, a multi-plate integrated LOMA 10 in accordance with the present invention includes a top plate 12 and a bottom plate 52, and also an RHPL 16 and DIFP 14 as described above. A first pattern of passages 54 is formed in the underside 56 of top plate 12, which as noted above may be expressed as a corresponding pattern of raised sections 42 on the upper surface thereof. Similarly, a second pattern of passages 58 is formed in the upper surface 60 of bottom plate 52. The oil passage patterns 54, 58 in plates 12, 52 cooperate to define and form the oil galleries of a complex three dimensional network for selectively distributing pressurized oil from an engine oil riser (not shown).

Plates 12, 52 preferably are formed of a thermoplastic polymer having a relatively high melting temperature, for example, a glass-filled polyphthalamide (PPA). Top and bottom plates 12, 52 may be joined along mating surfaces thereof by fusion, such as, for example, by vibration welding wherein the plates are urged together, at a loading of about 200-400 pounds per square inch, preferably about 300 pounds per square inch of mating surface, and are vibrated past each other, preferably at a frequency of about 120-240 Hz. Under these conditions, the mating surfaces liquefy, compress, and fuse in a fusion zone, forming a mechanical and hermetic seal defining the oil galleries in integrated LOMA 10.

Bottom plate 52 includes a plurality of sockets 62 for receiving a plurality of solenoid-actuated OCVs 64 for controlling oil flow from patterns 54, 58 to individual valvetrain valve deactivation means (not shown) in a deactivation-equipped engine 38. As noted above, within the scope of the present invention, such deactivation means may include but is not limited to DHLAs, DHVLs, and DRFFs.

In one aspect of the invention, an oil supply passage and jet orifice 43 are provided for supplying and spraying lubricating oil onto socket 26 and head 28 from an end of second plate 52 via pattern 58.

Control valves 64 extend through bottom plate 52 and the valve heads thereof seal against seats (not shown) in bottom plate 52. Each of control valves 64 controls the activation and deactivation of all DHVLS (intake and exhaust) for a given cylinder of a multi-cylinder engine via outlet ports (not visible) in integrated LOMA 10; thus, four control valves 64 are required, for example, to deactivate valves for four cylinders of a bank of an eight-cylinder V-style engine.

Solenoid-activated OCVs 64 may be retained in their respective sockets 62, for example, by a separate retainer (not visible in FIG. 4) or by having individual flanges that can be thermally welded to bottom plate 52.

An electrical leadframe or wiring harness 70 for supplying electrical signals from an Engine Control Module (not shown) to the solenoids of OCVs 64 is attached thereto, preferably by spade connectors 72, and extends through port 46 (see also FIG. 1) in top plate 12, terminating in an electrical connector 74.

While the invention has been described in reference to a V-type engine, it is understood that the invention is applicable to other type engines. For example, the integrated assembly, in accordance with the invention, could be part of a cam cover in an overhead cam engine wherein the RHPL is driven by a lobe on the overhead camshaft.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. An integrated assembly for supplying oil and fuel to components of a multiple-cylinder internal combustion engine, comprising:
a) a body containing a network of oil passages for distributing engine oil to a plurality of valve-deactivating hydraulic mechanisms;
b) a fuel pump disposed on said body for delivering fuel to an engine fuel rail; and
c) a pump lifter mated with said fuel pump for engaging a camshaft lobe of said engine to operate said fuel pump.

2. An integrated assembly in accordance with claim 1 wherein a camshaft supporting said camshaft lobe includes an axis of rotation, the pump lifter includes a longitudinal axis, and said longitudinal axis intersects and is perpendicular to said camshaft axis of rotation.

3. An integrated assembly in accordance with claim 2 wherein the camshaft supporting said camshaft lobe includes at least one valve actuating lobe for actuating at least one combustion valve of said multiple-cylinder internal combustion engine.

4. An integrated assembly in accordance with claim 1 wherein said body is formed of a single plate.

5. An integrated assembly in accordance with claim 1 wherein said body is formed of a plurality of plates.

6. An integrated assembly in accordance with claim 1 further comprising:
a) at least one solenoid-operated control valve disposed on said body; and
b) an electrical conductor attached to said solenoid-operated control valve for activating said solenoid.

7. An integrated assembly in accordance with claim 6 comprising a plurality of solenoid-operated oil control valves.

8. An integrated assembly in accordance with claim 6 wherein said electrical conductor is selected from the group consisting of a leadframe and a wiring harness.

9. An integrated assembly in accordance with claim 1 wherein said network of oil passages includes a passage for supplying lubricating oil to at least one of said fuel pump and said pump lifter.

10. An internal combustion engine comprising an integrated assembly including
a body containing a network of oil passages for distributing engine oil to a plurality of valve-deactivating hydraulic mechanisms,
a fuel pump disposed on said body for delivering fuel to an engine fuel rail, and
a pump lifter mated with said fuel pump for engaging a camshaft lobe of said engine to operate said fuel pump.

11. An internal combustion engine in accordance with claim 10 wherein said network of oil passages includes a passage for supplying lubricating oil to at least one of said fuel pump and said pump lifter.
